(19) United States
(12) Patent Application Publication
(10) Pub. No.: US 2005/0144022 A1
(43) Pub. Date: Jun. 30, 2005

(54) Web-based system, method, apparatus and software to manage performance securely across an extended enterprise and between entities

(76) Inventor: Lori M. Evans, Bellingham, WA (US)

Correspondence Address: Lori Evans, 4410 Parkhurst Drive, Bellingham, WA, 98229, US

(21) Appl. No.: 10/746,166

(22) Filed: Dec. 29, 2003

(51) Int. Cl. G06F 17/60; G06F 7/00; G06F 17/30; G06F 17/00; G06F 15/16

(52) U.S. Cl. 705/1; 707/100; 707/3; 709/209

(57) ABSTRACT

A Web-based system, method, apparatus and software that enables capture, integration, filtration, aggregation and collaboration of corporate performance-related data from unlimited, but at least one local system, as well as manual data entry; organization of corporate performance-related data into unlimited, but at least one corporate performance-related metric; preparation of an interpretation of the data; provision for interactive, on-line access to the system; provision for security at all times in transit, as presented, when queried and as stored; a historical audit trail; secure archival of the corporate performance-related data and support materials; and provision to communicate with individuals for performance evaluation and improvement as it relates to corporate performance. The system may be securely hosted and accessed by an unlimited number of authorized users from any where in the world from any Internet connection.

### BACKGROUND

The invention relates to a corporate performance management system that facilitates the capture of key corporate performance drivers in the form of corporate performance-related data, financial and non-financial, qualitative as well as quantitative, converted to useful metrics, including data or data sets that may not be readily accessible or may not be stored electronically; fits into any existing information technology infrastructure; encourages accountability at all levels; evaluates and monitors corporate performance results and indicators at the corporate and individual levels; and encourages collaboration across the extended enterprise and even between business partners anywhere in the World, timely, within a secure, accessible Web-based environment.

An organization may spend thousands of dollars and hours setting up sophisticated business intelligence or budgeting and planning systems within their enterprise. Today, these systems typically require technical experts or financial analysts to manage and support them, adding an ongoing extra layer of cost. Today, these sophisticated systems are out of reach for small and even medium-sized organizations.

Today, most Business Intelligence or Budgeting and Planning systems claim corporate performance management capability. However, while these systems may provide extensive detail about past performance, the data is mostly financial and is not automatically linked to strategy or to individual performance. These systems do little to promote a future of improved corporate performance, which necessarily includes management of compliance, privacy and security, innovation, learning and governance.

Systems currently relied upon to manage corporate performance do not encourage, and are often not capable of, collaboration among all entities and individuals as they affect corporate performance, which may include outsource vendors, suppliers, contract workforce, consultants, independent brokers or distributors, etc.

Identifying corporate performance metrics that can be managed and that hold meaning for all individuals whose actions can affect corporate performance is important. Of those organizations that create strategic plans and objectives, including those that generate some type of scorecard, few, if any, define and capture metrics that fully express their vision, mission and strategy. Even the most robust corporate performance management systems with balanced scorecard applications do not supply the tools to aid the capture of data and metrics that would more fully represent their strategy; the systems available today only help manage what is currently captured, with most requiring the data or metrics to be in electronic form and many requiring a strictly defined or proprietary platform. Many executives view their current systems and the data available from those systems as good enough to manage their business. We have recent evidence, across industries, that current corporate performance systems within U.S. businesses are not good enough; they do not support the timeliness and transparency needed to provide useful information to stakeholders.

Capturing the data needed to accurately and wholly express corporate performance as defined by strategy and stakeholder needs can involve significant manual effort and can be costly and slow. Organizations may be required to assemble data from several disparate sources, synthesize and analyze the data, and develop conclusions based on the analysis. It can be challenging to accomplish these tasks in a timely manner. Automating these processes can have a significant favorable impact on the cost efficiency of corporate performance management.

Monitoring progress toward corporate goals can also be difficult and costly. In a traditional environment, this requires management to address every employee at the frequency equal to the frequency of the metric they can affect, which can be daily and is typically not less frequent than monthly. Capturing the results of ‘management by walking around’ can be time consuming and expensive, as well as ineffective when not considered with respect to strategic goals. Timely monitoring of corporate performance is more cost efficient when an appropriate technology is used. Corporate performance, as affected by the extended enterprise, which can reach outside the organization and to anywhere in the world, may be impossible without leveraging the Internet.

Managing and influencing progress toward performance goals can also be very challenging. Causal relationships between various metrics can be very complex and difficult to understand. Managers in organizations may require years of experience to develop an understanding of these relationships. Furthermore, the learning may not be retained when the experienced manager leaves the organization. Decisions that are made based on information may be incorrect if, for example, the information is not provided in a timely manner, if the analysis is incorrect or if the presentation is not in a form that can be synthesized by the user. Without frequent communication between decision-makers, their workforce and key business partners and shared accessibility to a single translation of the truth and supporting data, it can be difficult to align individual and group efforts to best support an organization's progress toward its performance goals.

If users of a corporate performance management system are unsure of the security of the data or the confidentiality of their communications, they will not use it to its full potential and the system will fail in bringing the expected benefits to the organization.

### BRIEF SUMMARY OF THE INVENTION

The invention is unique in that it coordinates Web-based interacting parts so as to easily incorporate and integrate all forms of data related to corporate performance and encourage collaboration across an extended enterprise via the Internet. It is also unique in its robust, detailed and flexible approach to securing data as it is transmitted and received electronically, as it is communicated between individuals via the Internet, as it is presented or queried and as it is stored and retrieved. Corporate performance-related data, which heretofore had to be restricted to a Microsoft Excel-type spreadsheet, or similar tool, for compilation and presentation can now be organized into a form that is readily accessible to disparate users, as authorized, whose input can be imported for further refinement and update. The invention provides a more accessible, cost-efficient and secure means to collaborate, to improve accountability, timeliness and transparency and to gain insight into the drivers of corporate performance through use of Web-services technology to harness the any time anywhere accessibility of the Internet, scalable architecture that will fit into any information technology infrastructure, intuitive application interfaces for ease of use by non-technical individuals and embedded security policies and mechanisms to provide peace of mind to users, to best ensure the system will be used to its fullest potential.

### DETAILED SUMMARY OF THE INVENTION

In a first aspect of the invention, a method is disclosed that includes identifying and capturing corporate performance related data from at least one remotely located application server; filtering, aggregating and organizing captured data into metrics; preparing an interpretative presentation of the data; providing interactive, on-line access to surveys, organized and concisely presented metrics, plans, strategy maps, comments, formulas, notes and supporting data, employee evaluations and ratings, tests, ad hoc query and assessment, analysis and management reports, and online help in many forms; and the means for an individual user to communicate securely with others at anytime and anywhere in the World. Corporate performance related data may also be obtained from an unlimited number, and at least one, locally stored application. The data may be organized at an individual level, a group level and an enterprise level and may be filtered and aggregated into at least one metric that is aggregated at every reporting level above the level at which the metric was captured. The method may also identify whether a value for a given metric has met, exceeded or not met a targeted value for the metric and if the value indicates an alarm should be presented to the user. The method may include comparing the value of a metric to predetermined values set as actions, initiatives or events such that a user may receive an email alert. The metrics may be organized into categories. A historical audit trail is maintained of the corporate performance data and related data, including access and attempted access to the data. The method may include securing the corporate performance data in transit, as presented, as queried and as stored. The method may include a means to assess readiness for manual or electronic capture of corporate performance and related data, report on the survey results and automatically generate a detailed action plan. The method may further include a means to evaluate and test individuals with respect to their performance as it relates to corporate performance.

In a second aspect, a system is disclosed that includes at least one remotely located application server, at least one database server located locally or remotely; a computing device with Internet connectivity; and a local processor device. The processor device is configured to obtain corporate performance related data from at least one remotely located application server; organize the corporate performance related data into at least one metric; organize and respond to survey results, prepare action plans; organize captured data into metrics; prepare an interpretative presentation of the data; provide interactive, on-line access to the survey, the metrics as organized, plans, means for communication with others and to receive help; and secure to ensure availability only for authorized users and only with respect to the data, data sets, reports, functionality or other aspects of the system that they are authorized to access. The system may also provide a means to move all or selected data from one or many systems, with unlimited frequency and without manual intervention, through a processor device and to at least one database server. The system may include unlimited, and at least one, locally stored application from which the processor device may obtain corporate performance data. The system may further provide access to users via a Web browser window, which may be located by the user via a desktop shortcut icon or direct entry of a uniform resource locator (URL). The processor device may be further configured to organize survey responses at an individual level, a group level, and an enterprise level, categorize the survey responses in accordance with predetermined action steps, report survey results and automatically generate a detailed action plan that is linked directly to the survey results. The processor device may be further configured to filter and aggregated data to generate metrics in accordance with a predetermined formula and organize the data at an individual level, a group level, and an enterprise level and to organize the at least one metric into at least one category. The processor device may also be configured to identify if a predetermined set value, for the data organized into the at least one metric has been met, exceeded or not met, compare a value of at least one metric with a value of an event, initiative or action plan assigned to that metric such that an automated response is delivered to an identified authorized user via the Internet. The processor device may be further configured to privately route or publicly broadcast each communication from an individual, or to automatically generate a communication, to the intended receiver(s) and/or to the intended presentation view or report within the corporate performance management system. The processor device may be further configured to maintain an historical audit trail of the corporate performance and related data, including access and attempted access to the data. The system may be secured during communications, presentation and storage of the data. The system may further include a means to evaluate and test individual performance as it relates to corporate performance.

In another aspect, an apparatus is disclosed that includes at least one processor; at least one Web server, at least one memory unit, at least one personal computing device with Internet connectivity and at least one technical security mechanism. The apparatus may provide the means to securely receive and transmit all or selected data from one or more systems via VPN or encrypted over the Internet, with unlimited frequency and without manual intervention, through a processor device and store the data on at least one memory unit such that is secured as stored and retrievable at anytime from anywhere in the World and only by authorized users. The apparatus may further enable the concise interactive compilation and presentation of corporate performance management data to multiple, and at least one authorized user(s), at any time and from anywhere, from a personal computing device with Internet connectivity.

In yet another aspect, an article is disclosed. The article may include a computer-readable medium that stores computer executable codes that instruct a computer system to obtain corporate performance data from at least one remotely located application server or from at least one database located locally or remotely; filter, aggregated and organize the corporate performance data into at least one metric; further aggregate and organize the corporate performance metric for reporting at all levels above that level at which the metric is captured; and provide secure, interactive access through the Internet to the corporate performance data as organized and concisely presented within a single Web browser window accessed with a single sign on or biometric authentication. The computer readable medium may be comprised of at least one digital data storage medium having a computer readable code stored thereon; a first set of data stored digitally on a data storage medium and having contained therein data concerning strategic objectives, related metrics and levels of exception identified as targets and alarms for each metric; a second set of data stored digitally on a data storage medium and having contained therein the organizational structure and assigned responsibilities; a third set of data stored digitally on a data storage medium and containing sample metrics and benchmarks from successful corporate performance management systems, along with prescribed action steps given various levels of readiness by type of metric, importance and level of responsibility; a third set of data stored digitally on a data storage medium and having contained therein the historic and current actual performance data captured daily, weekly, monthly, quarterly and annually. The article may instruct the computer system to enable user access from a Web browser to all or selected aspects of the system and software applications, all within a single browser window accessed using a single sign on or biometric authentication. The article may also instruct the computer system to enable real-time access for authorized users to one or more of the following aspects of computer readable medium: respond to a series of questions related to the availability and form of data critical to the reporting of corporate performance; review plans with respect to data capture; view strategic plans; create or view strategy maps; view interactive presentation of corporate performance results within a balanced scorecard framework; drill down from a presented metric to the individual data elements comprising that metric, at their root level; or evaluate employees with respect to their performance and corporate strategy. The article can include instructions for causing the computer system to allow authorized users, without exiting the single Web browser view or any software application, to perform one or more of the following activities: create and share comments with other authorized users; upload or download supporting documentation; perform ad hoc database query on the fly; and create and communicate events, initiatives and action plans to be monitored systematically and communicated automatically via the Internet. The article may further instruct the computer system to allow an authorized user to access and interact with a survey, training, testing, employee evaluation, performance scorecard, reports, ad hoc database query and help desk. The article may include instruction to obtain corporate performance related data from at least one locally stored application. The article may also instruct the computer to organize survey responses at an individual level, a group level and an enterprise level, and categorize the survey responses in accordance with predetermined action steps. The article may instruct the computer to filter, aggregated and organize data to generate metrics in accordance with a predetermined formula and organize the data at an individual level, a group level, and an enterprise level; group metrics into at least one category; determine whether a predetermined set value, for the data organized into the at least one metric, has been met, exceeded or not met; and compare at least one metric with an event, initiative or action plan assigned to that metric such that a automated response may be delivered via the Internet. The article may include further instructions to maintain an historical audit trail of the corporate performance data, including access and attempted access to the data. The article may include instructions to secure data to only authorized users during communication, presentation, query, reporting and as stored. The article may further include computer instructions to aggregate and report individual evaluation, rating and testing results related to individuals and to submit results related to corporate performance to a database for further management in a balanced scorecard or for secured and confidential ad hoc reporting.

### BRIEF DESCRIPTION OF DRAWINGS

FIGS. 1A-D, 3A-E are block diagrams of the method according to the invention.

FIGS. 2A-C, 3G-4A are block diagrams of the system according to the invention.

FIG. 5 is a block diagram of the apparatus according to the invention.

FIGS. 3F-G, 6A-F are block diagrams of the article according to the invention.

### DETAILED DESCRIPTION OF THE DRAWINGS

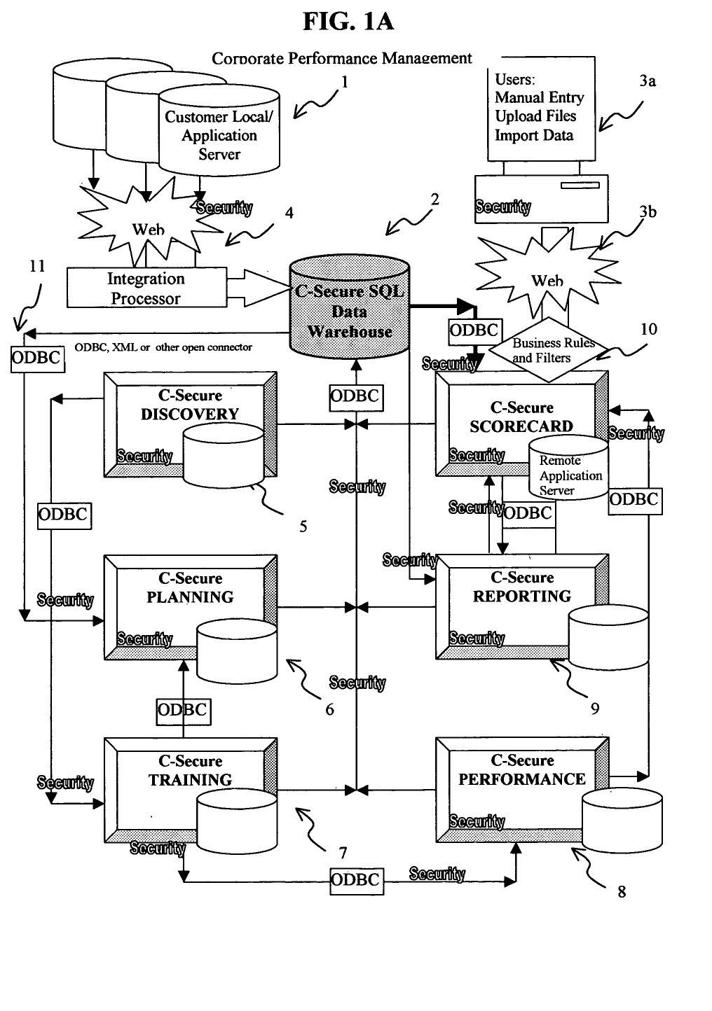

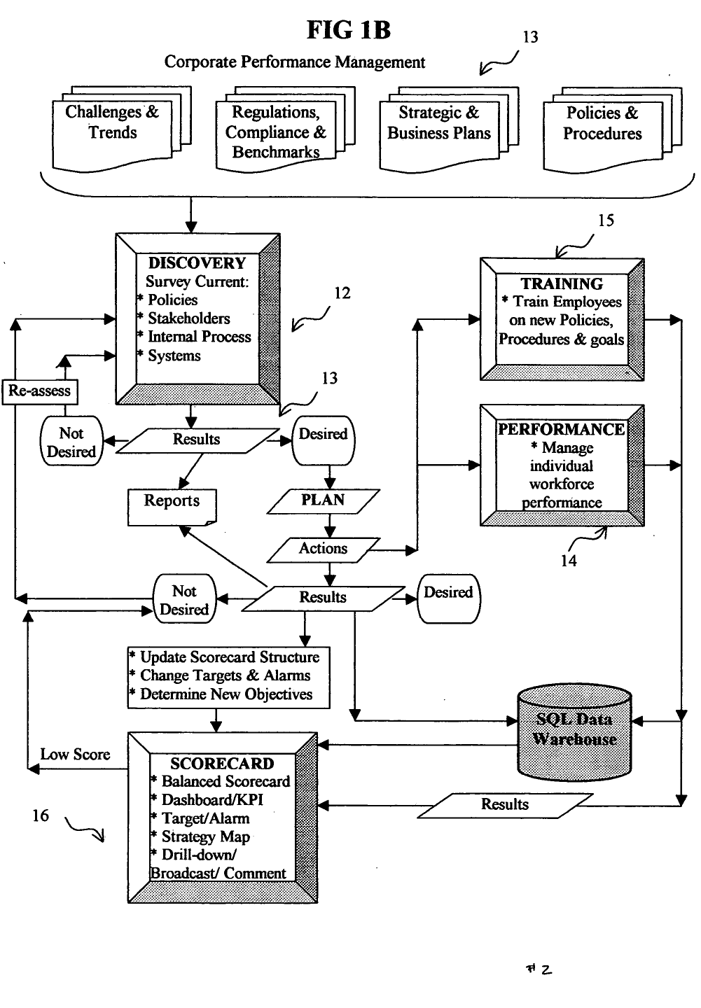

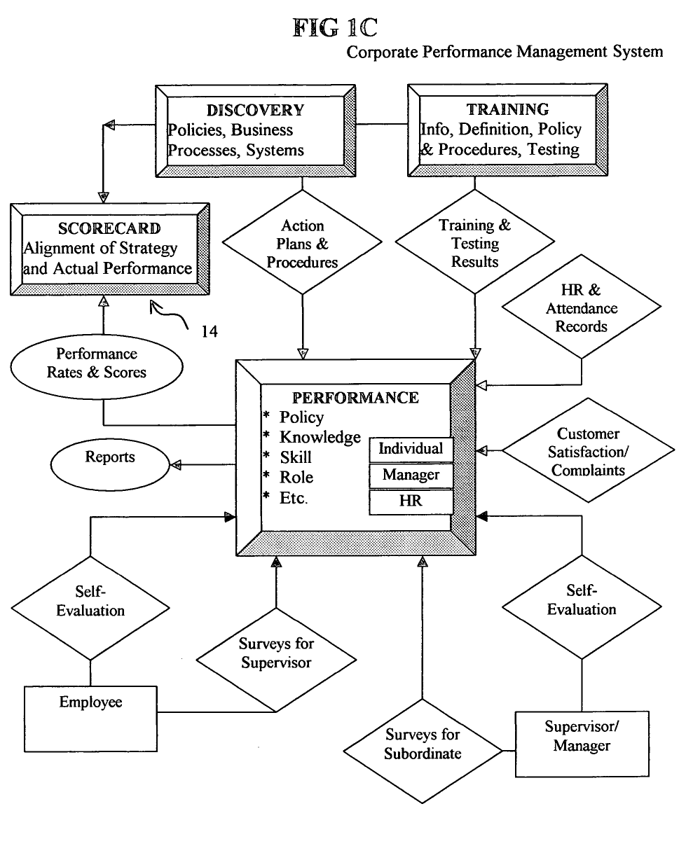

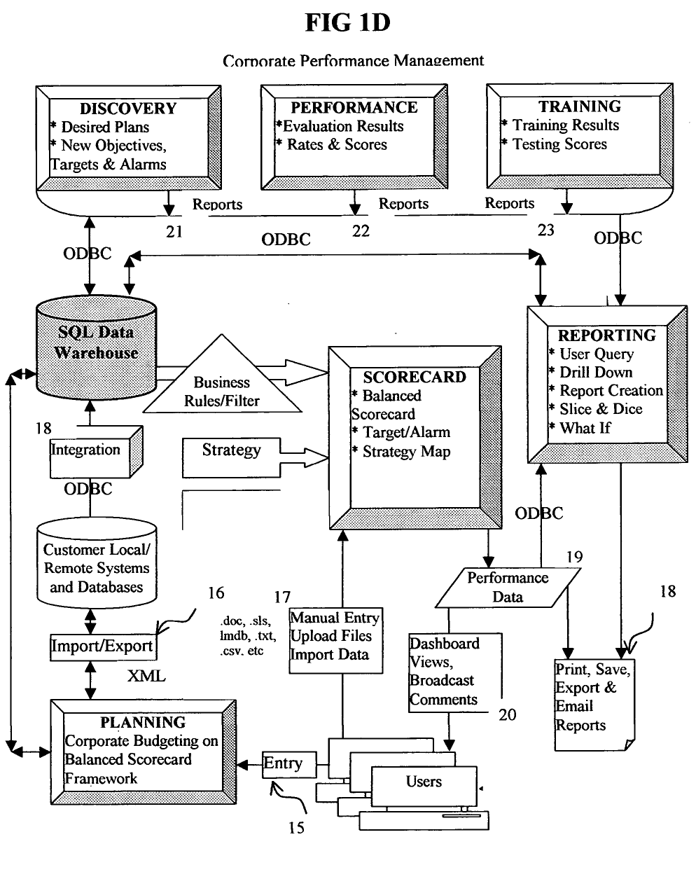

FIG. 1A is a diagram illustrating the system, comprising: at least one remotely located application server (1); at least one database server located locally or remotely (2); a computing device with Internet connectivity (3); and a local processor device (4); wherein the processor device may be configured to obtain corporate performance data from the unlimited or at least one remotely located application server at least one database server and a Web server, and the article comprising a computer-readable medium that stores computer executable instructions for causing a computer system to: obtain corporate performance related data from at least one remotely located application server. In this diagram, the computer readable medium may be comprised of six software applications, entitled, “Discovery (5),” “Planning (6),” “Training (7),” “Performance (8), ““Reporting (9),” and “Scorecard. (10)”

FIG. 1A further illustrates how existing data may be consolidated from at least one local application server by creating a direct, electronic link between the local systems and at least one local or remote database server, which is an open database connectivity (ODBC)-compliant database (11) with ODBC, XML or other open connectors. If the local application server is not ODBC-compliant software code may be added as a middle layer and then the direct, electronic link to at least one local or remote database server is created.

FIG. 1A further illustrates the means by which data may be transferred from at least one local application server, and typically from several disparate systems, through a secured (SSL) Internet or Intranet connection and into the ODBC-compliant database, which is readable in standardized query language (SQL).

FIG. 1A further illustrates the process by which data not previously collected electronically can be manually entered into an interface accessed through a Web browser.

FIG. 1A further illustrates how data collected electronically but external to the direct transfer described in [0019] can be incorporated via a file upload. File formats such as .doc, .xls, .csv, .txt. .mdb are easily uploaded from a local computer to the database server through a Web browser interface, making the files accessible via Web browser to all authorized users from this single, central (database) location

FIG. 1B is a block diagram and flow diagram combined to illustrate how the readiness assessment and planning application, entitled “Discovery (12),” aids definition and planning for the capture and measurement of corporate performance related data, especially data that may be critical to strategy (13) and not yet captured in a timely and useful way, may be integrated with other applications within the system, including individual employee evaluation (14), training (15) and a balanced scorecard (16).

FIG. 1B further illustrates a feature of the invention associated with the readiness assessment and planning application described in [0023] wherein a customized survey may be associated with predetermined next steps and recommendations, grouped into one or more category for reporting and automatic generation of a MS Project Plan (13). A bi-product of the reporting process is an assessment of readiness and recommendation, which can be sent to applications for training, employee evaluation and a scorecard.

FIG. 1C illustrates the data that are tracked in the individual evaluation and testing application, entitled, “Performance.” The application aids the evaluation and rating of an individual's work performance, skills, knowledge, work ethics, workflow, productivity, rewards, satisfaction, goals attainment, compliance of policies and procedures, etc.

FIG. 1C further illustrates the filtering, aggregation and organization of the individual performance and evaluation and tracking relative to corporate performance for integration with the corporate scorecard (14) to export evaluation rating and test results to the scorecard and import other metrics from the corporate scorecard, such as revenue growth, customer satisfaction and policy compliance, etc. for use in employee evaluation.

FIG. 1D illustrates the integration of all corporate performance-related data wherever it resides, via manual entry (15), file import (16), file upload (17) or systems integration (18). The invention affords computer readable medium aiding corporate planning (“Planning”), corporate performance management readiness assessment and action plans (“Discovery”), individual evaluation and testing (“Performance”), performance and related training (“Training”), business intelligence tool (“Reporting”) and a balanced scorecard application (“Scorecard) that integrate to form the complete corporate performance management (CPM) system.

FIG. 1D also illustrates a critical feature of the invention, which is the ability to gather corporate performance-related data through import and export via extensible mark-up language (XML) (16). Even very large files containing historical actual and planning data can be quickly transmitted between the invention and client financial systems using the XML import function. The export function may be used to transmit the final planning data to a client system, to presentation-quality reports or to Excel, “Reporting” or other analytical tool for what-if analyses. Standard built-in importable files accessible to users at any time from within the invention include .doc, .xls, .mdb, .txt, .csv (17).

FIG. 1D further illustrates the collaborative nature of the method of the invention, wherein users from various locations can manually enter (15) or import data (16)(17) in real-time from anywhere there is an Internet connection. This real-time interactive Web-based application allows budgets to be gathered and aggregated instantly from all different departments, units or facilities globally.

FIG. 1D further illustrates the method by which the corporate performance data may be filtered, aggregated and interpreted in a concise presentation (18-23). These software codes instructing the processor to filter, aggregate and interpret the data can be executed on demand, or automatically on a schedule, and then loaded into the scorecard. Metrics, units of measure, date data was last updated, date of presentation, formula(s) used, comments and individual or responsibility code assigned to the metrics are available within the scorecard presentation to an authorized user.

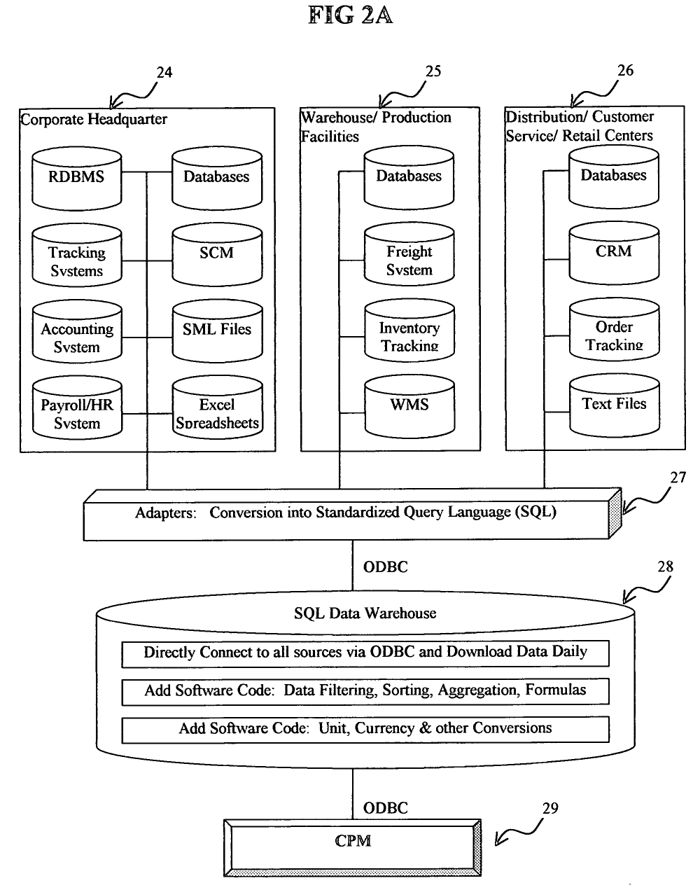

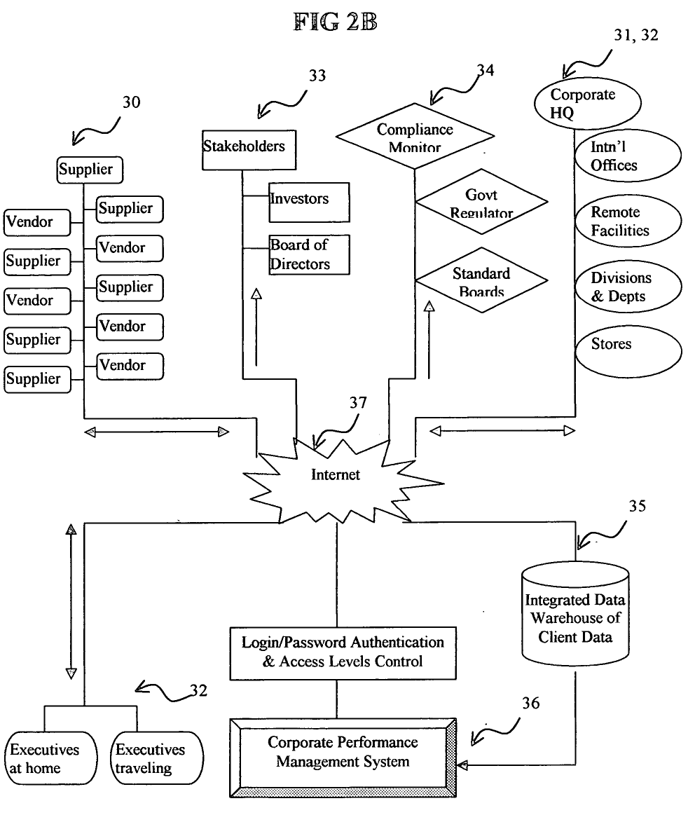

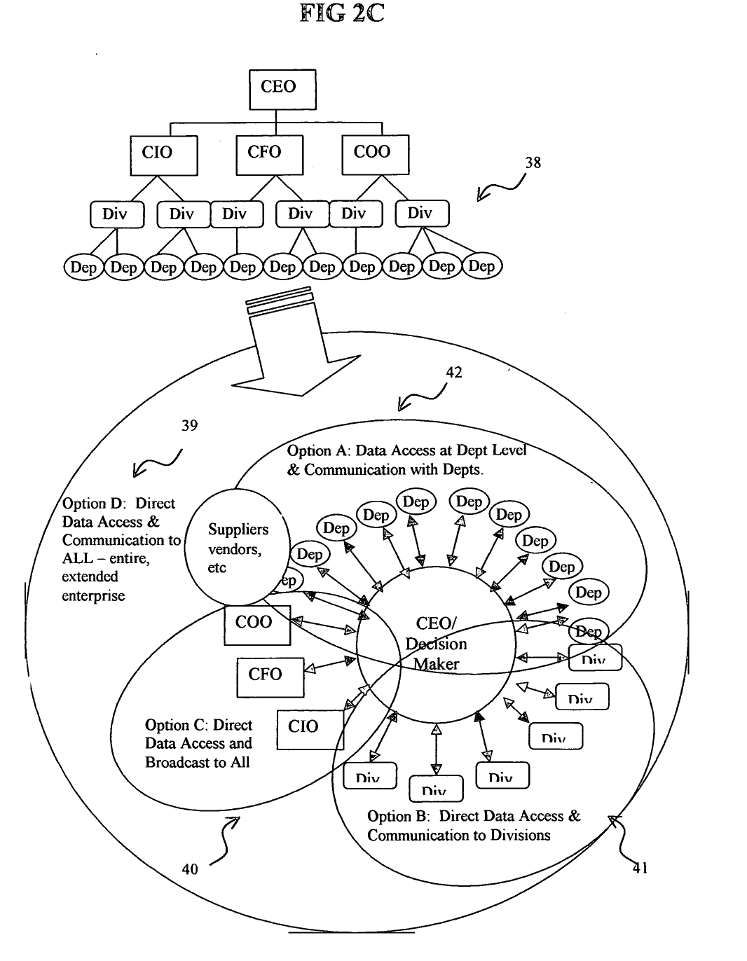

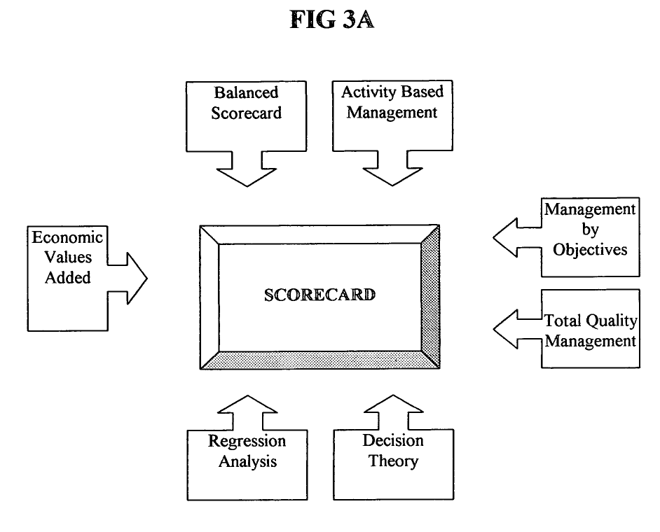

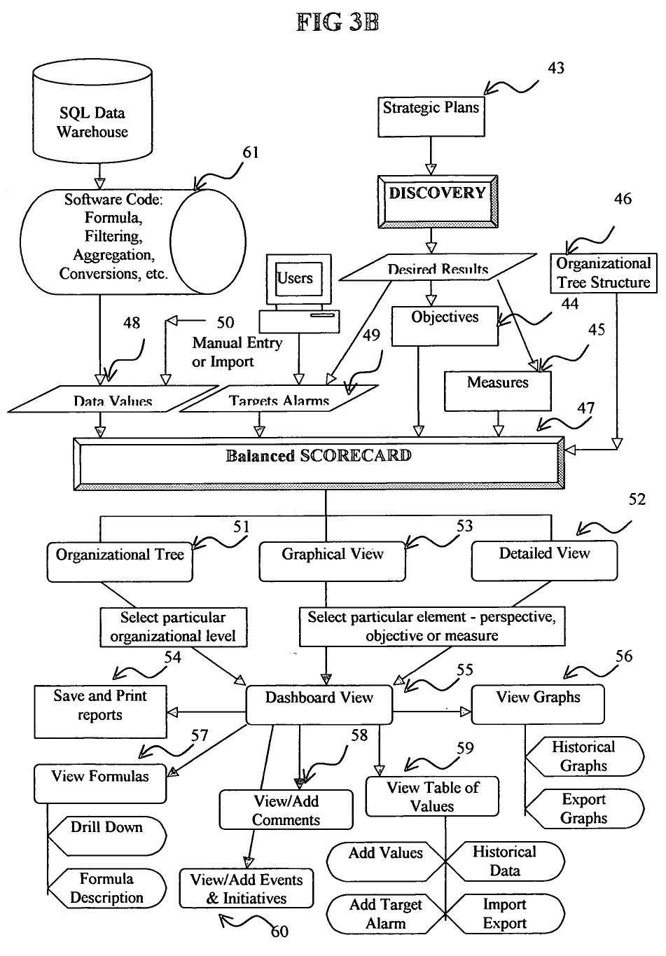

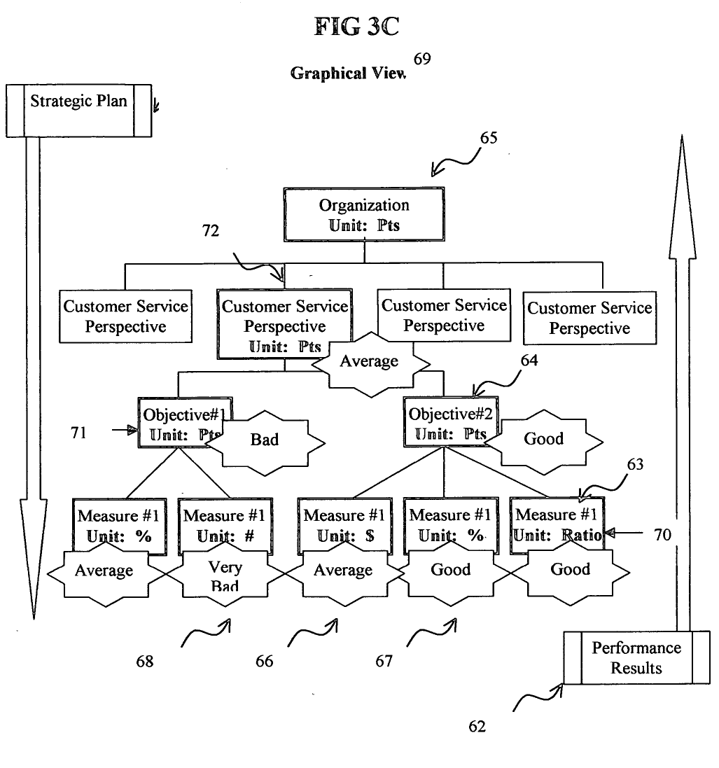

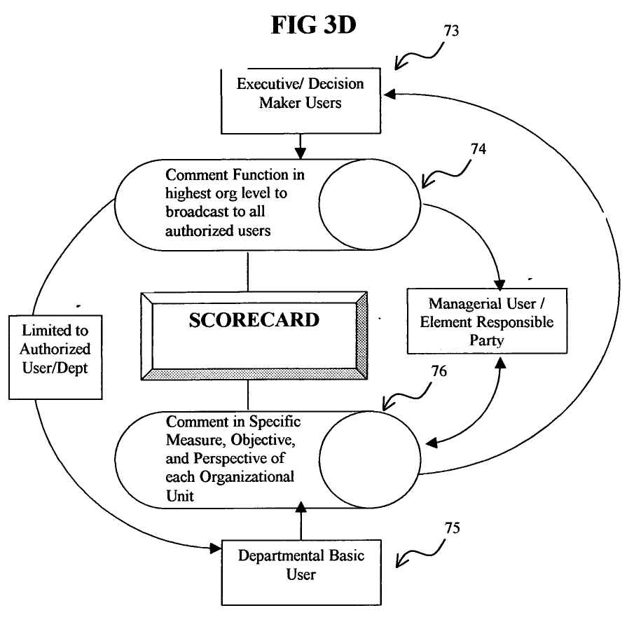

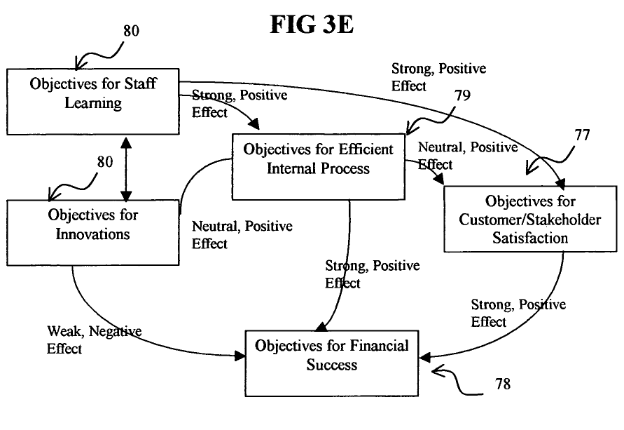

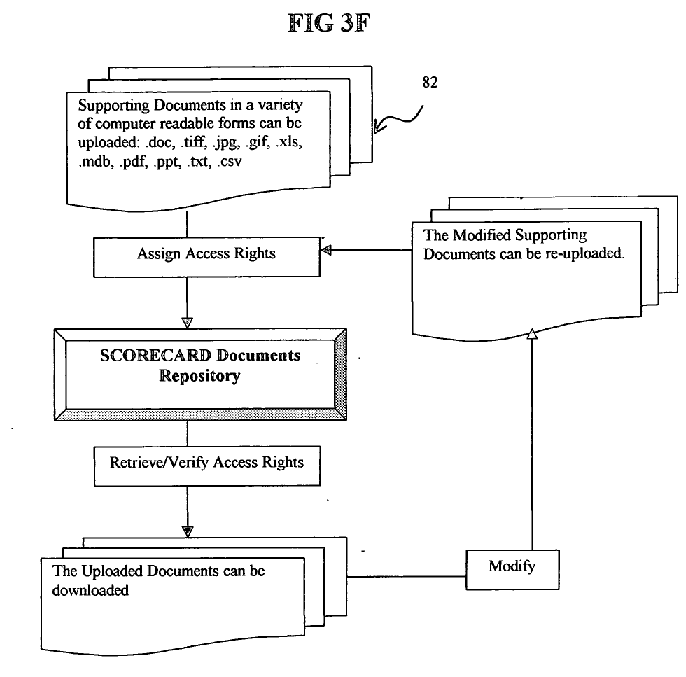

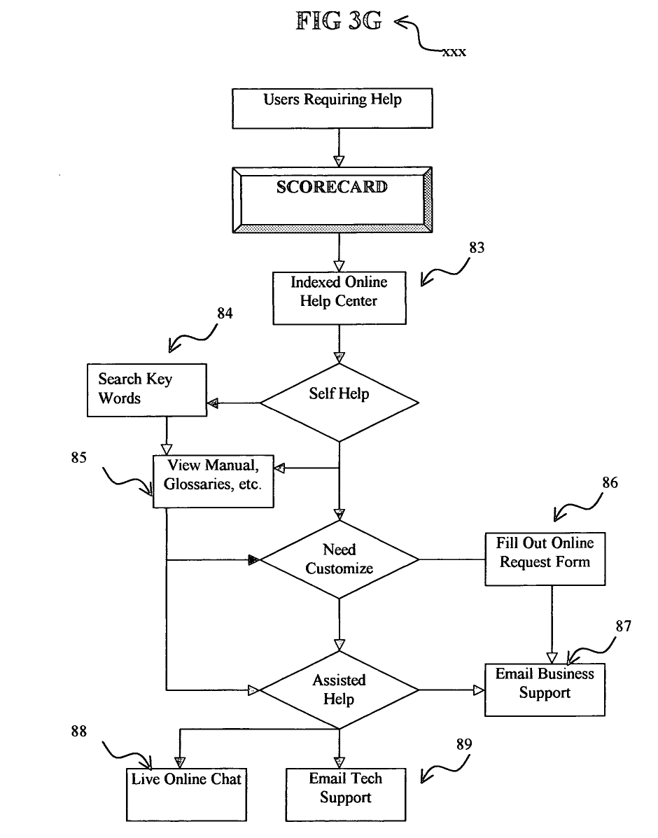

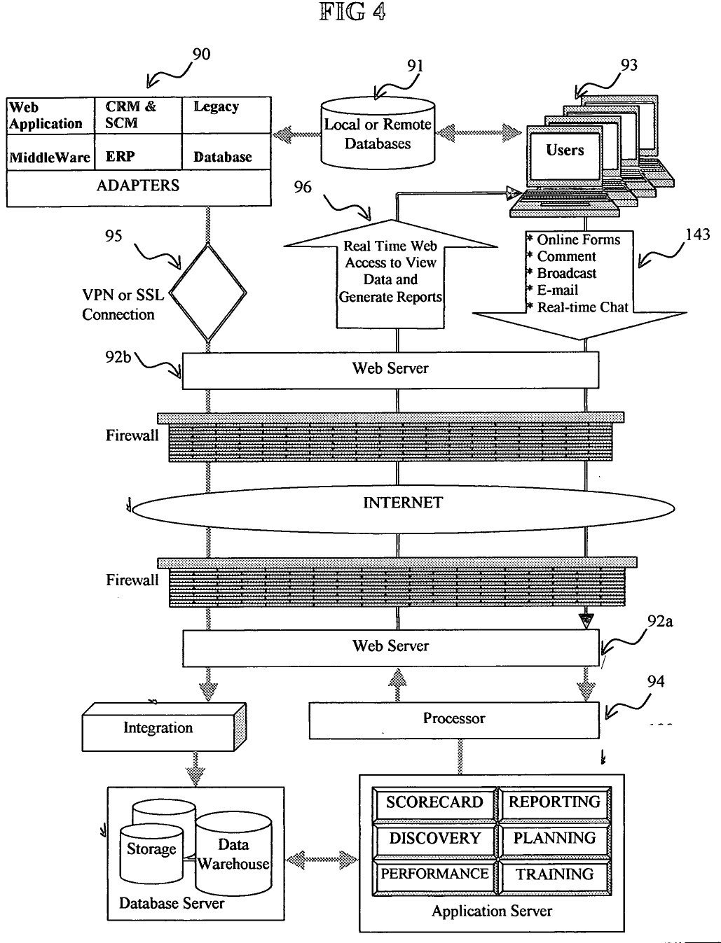

FIG. 2A illustrates the system of the invention, which enables transfer of all or selected data from one or more systems (24-26), with unlimited frequency and without manual intervention (27), through a processor device (28) and to at least one database server (29).

FIG. 2B illustrates the collaborative nature of the system of the invention wherein the extended enterprise (31), including vendors and suppliers (30), business associates and remote workforce (32), as well as corporate stakeholders (33), regulators (34), customers, etc., may share in the corporate performance data (35) and system (36) via the Internet (37).

FIG. 2C illustrates the timeliness and transparency of corporate performance data afforded by the invention. Strategy may be cascaded throughout the organization from decision-makers (38); individuals, actions, processes and systems are measured and monitored in a balanced scorecard framework; and corporate performance may be shared within a secure, collaborative environment (39-42).

FIG. 2C further illustrates the robust security levels afforded by the invention wherein access may be based on roles and organizational level, including but not limited to the following options: rights to allow full access to all areas of the system and all data (39); rights to access the full system but communication rights only to executives (40); rights to access the system and communicate with a subset (41) or rights to access a subset of the data and communicate within that subset (42).

FIG. 3A illustrates a selection of best practice methodologies incorporated into the invention.

FIG. 3B illustrates the aspect of the invention that is a balanced scorecard architected to exceed the general certification requirements from the Balanced Scorecard Collaborative and a Scorecard fully architected for the Internet. In general, the structure requires the ability to map strategy to actual performance (43), define objectives (44), and measures (45), assign measures to organizational levels (46), create a scorecard structure of perspectives, themes, objectives and measures (47), collect values (48), assign targets and alarms (49), aggregate that data into a scorecard framework (50), display the data respective to the organization (51), display the data respective to the strategy (52). Optional features (53-61) may be added to facilitate automation and presentation of the balanced scorecard.

FIG. 3B further illustrates the component-based structure of the invention's scorecard application and the flexible, intuitive, phased-in approach to capturing corporate performance-related data to fully align with strategic plans.

FIG. 3C illustrates the method by which corporate performance-related data (62) may be filtered and aggregated to generate at least one metric in accordance with a predetermined formula and the process wherein that metric may be organized at an individual level (63), a group level (64), and an enterprise level (65).

FIG. 3C further illustrates how the at least one metric may be presented graphically, such that its relationship with at least one corporate objective may be known and its comparative value relative to desired performance may be captured and shown to be as expected (66) or better than expected (67), less favorable than expected but within tolerance or under-performing and in need of intervention (68).

FIG. 3C further illustrates how the at least one metric may be combined with other metrics and aggregated into at least one metric at a higher level, including at least one metric at the corporate “Organization” level.

FIG. 3C further illustrates one type display, a Graphical View (69), available to a user of the corporate performance management system. Each measure in the scorecard component of the corporate performance management system may be compared against a user defined expected value (target) and alarm value. Data results are given standard traffic light coloring that can be customized to display different or additional colors.

FIG. 3C further illustrates the handling of dissimilar units of measure (70). When there are multiple measures in the scorecard to be aggregated and reported at several organizational levels, the measures are first converted into a standardized unit of measure before being combined and averaged. The measures are converted to a standard “Points” metric, relative to the relationship between actual, expected and alarm values and multiplied by a weight, which is a value of “1” by default or a different value if assigned by the user. The weights do not alter the traffic light color but rather indicate to the user the importance of that measure. The user may opt to view colors with a straight average and also view colors using the priority weightings or see one color for the results compared to expectation (traffic light) and a second color depicting priority weighting.

FIG. 3C further illustrates the use of a standard value, Points (Pts) (71), to facilitate concise presentation of corporate performance data. Once converted to Points, the data is aggregated using a weighted averaged of all existing Pts. under each objective. A user-defined weight can be assigned to automatically increase or decrease the weight of each measure when rolled up to the next level. The averaged result is shown as points for the overall performance of the objective within the organizational unit and is also graphically indicated with traffic light or customized coloring.

FIG. 3C further illustrates that objectives may roll up to themes and to Perspectives (72) using standards and weighted averages method. Perspectives are also rolled up to the level of overall enterprise Strategy (“Organization”).

FIG. 3D illustrates the collaborative nature within the article, as specifically the scorecard component, of the invention wherein comments may be broadcast by a decision-maker (73) to all or some scorecard users (74) and comments may also be provided privately from an individual (75), who is assigned responsibility for at least one metric, to their immediate supervisor (76). Comments are secured and made available only to those individuals authorized to view them.

FIG. 3E illustrates the method of the invention affording an expression and ultimate valuation and evaluation of the linkage between stakeholder perspectives and corporate objectives. Within the invention, at least one metric may be organized into at least one category. In this diagram of the invention, the metrics would be categorized as objectives and objectives are linked to four or five perspectives: Customer/Stakeholder Satisfaction 77), Financial Success (78), Internal Process (79) and Learning (80) and/or Innovation (81).

FIG. 3F illustrates how a user might be authorized to access, view and use corporate performance-related data available within the scorecard component of the corporate performance management system. The user may upload supporting materials into the document repository contained within the scorecard in order to avail that information to other users of the corporate performance management system. The “document repository” holds many file formats, including .doc, tiff, .jpg, .pdf, .xls (82).

FIG. 3G illustrates how a user might gain help while accessing the scorecard component of the invention. A user requiring help may: search an indexed help file (83); search key words (84); view a manual and glossary (85); complete an online form (86); send an email to the business support/customer service desk (87); chat live online with the help desk (88) and email tech support/help desk (89).

FIG. 4 illustrates the system of the invention, which includes at least one remotely located application server (90); at least one database server located locally or remotely (91); at least one Web server located locally or remotely (92); at least one computing device with Internet connectivity (93); and a processor device (94). The corporate performance management server may be managed (ASP) external to the organization or located on the customer's premises. In the case of an ASP model, the customer organization would require no technical resources or expertise other than what may be currently in place for their desktops or mobile computing equipment. Security may be built into the system (95) with administrator-controlled access (96).

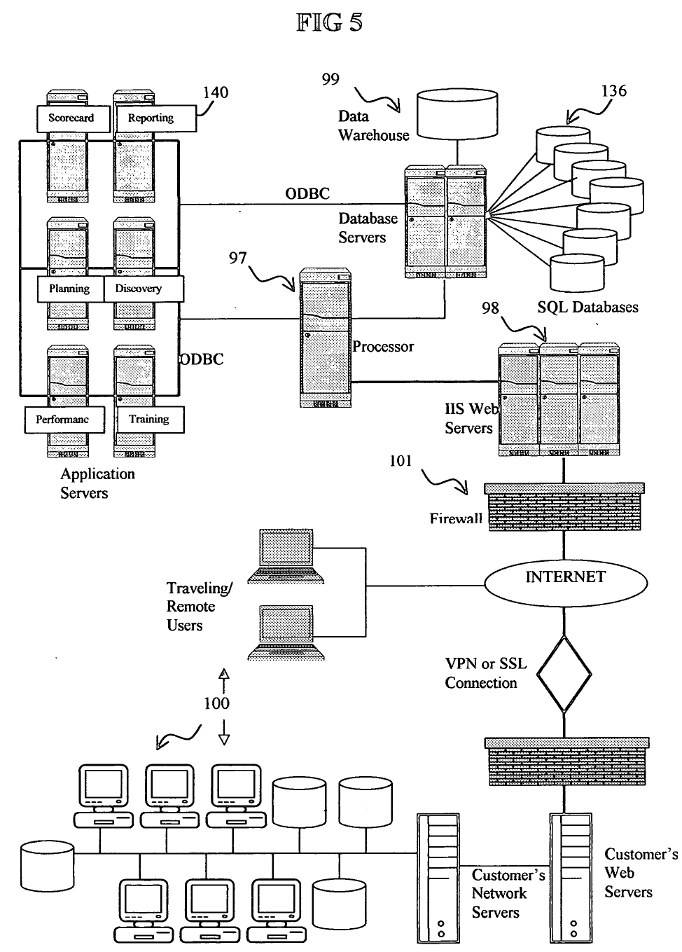

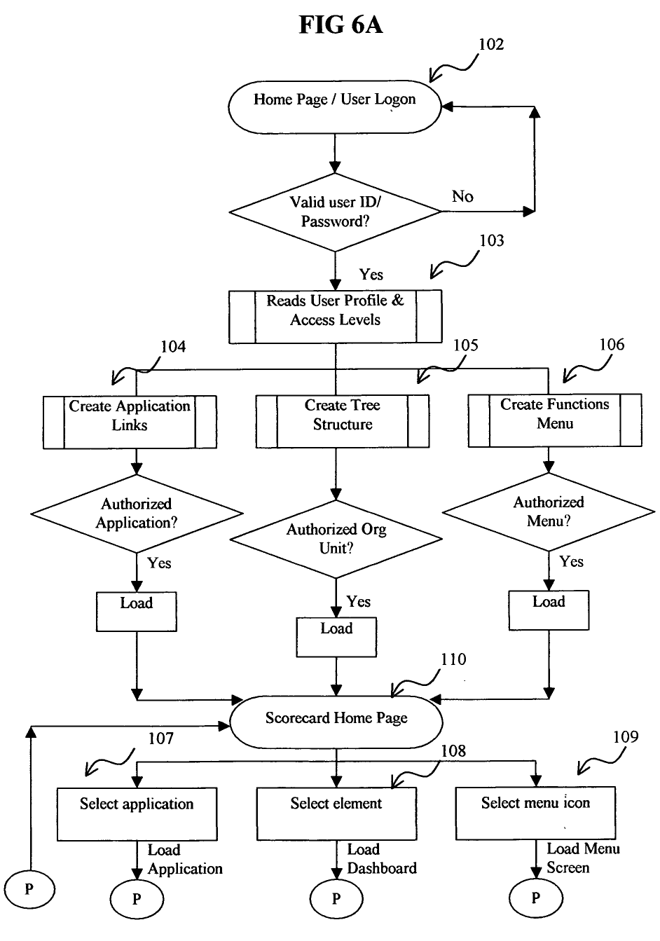

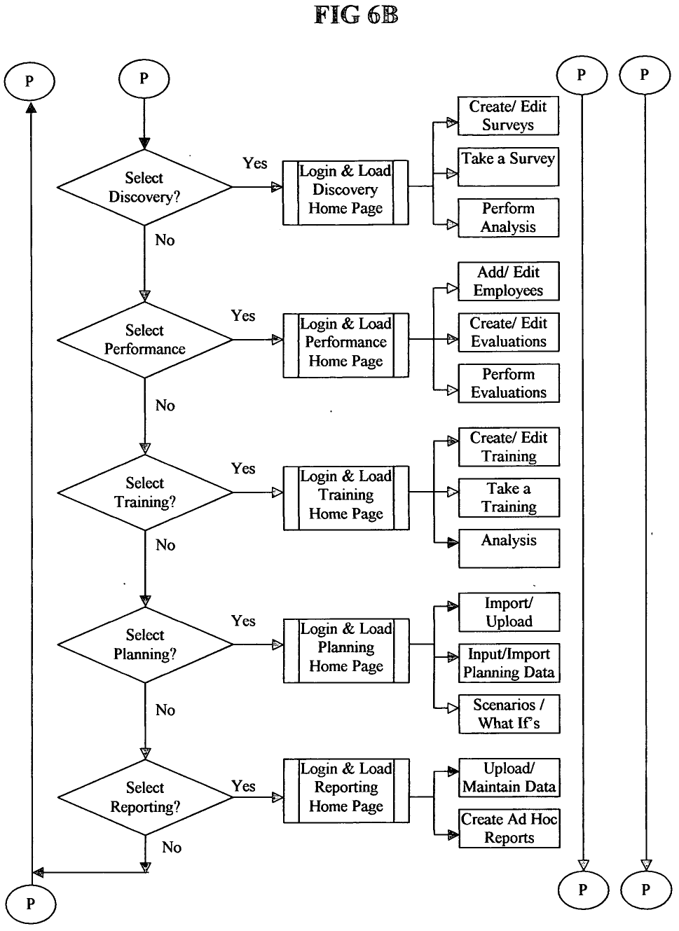

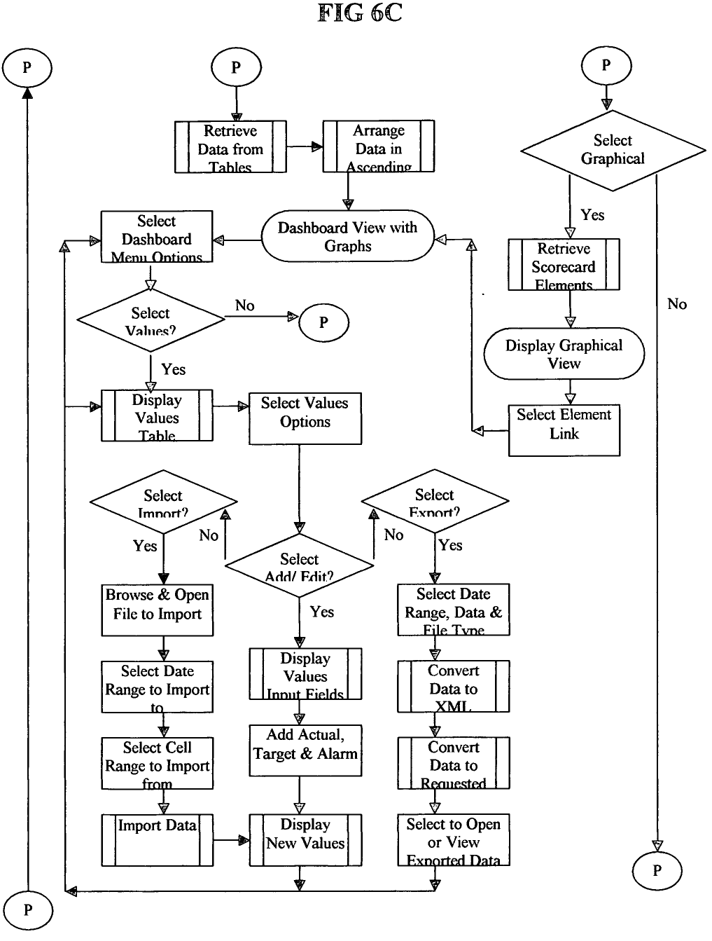

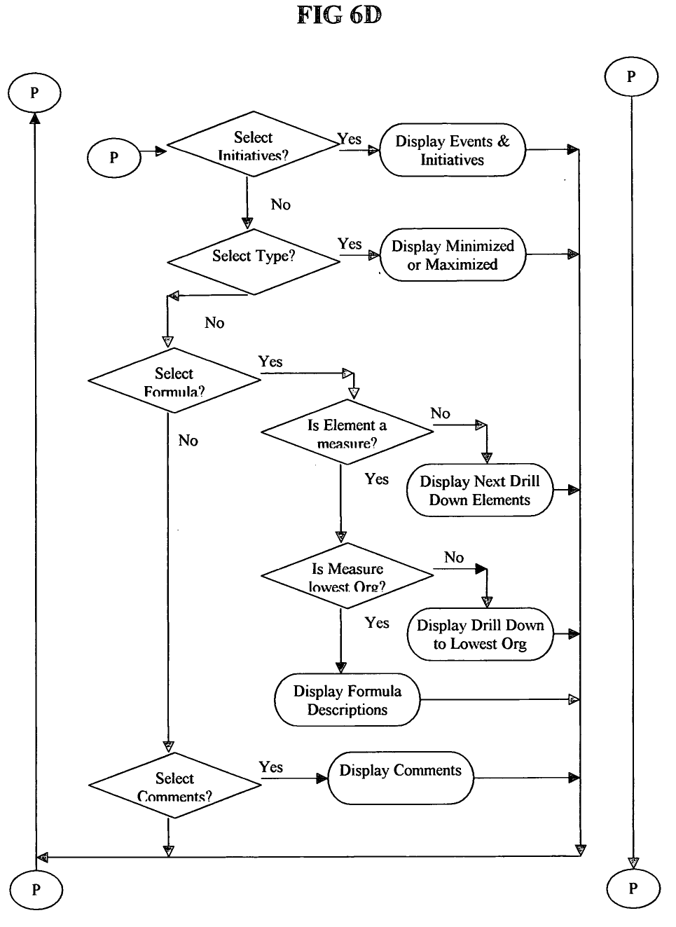

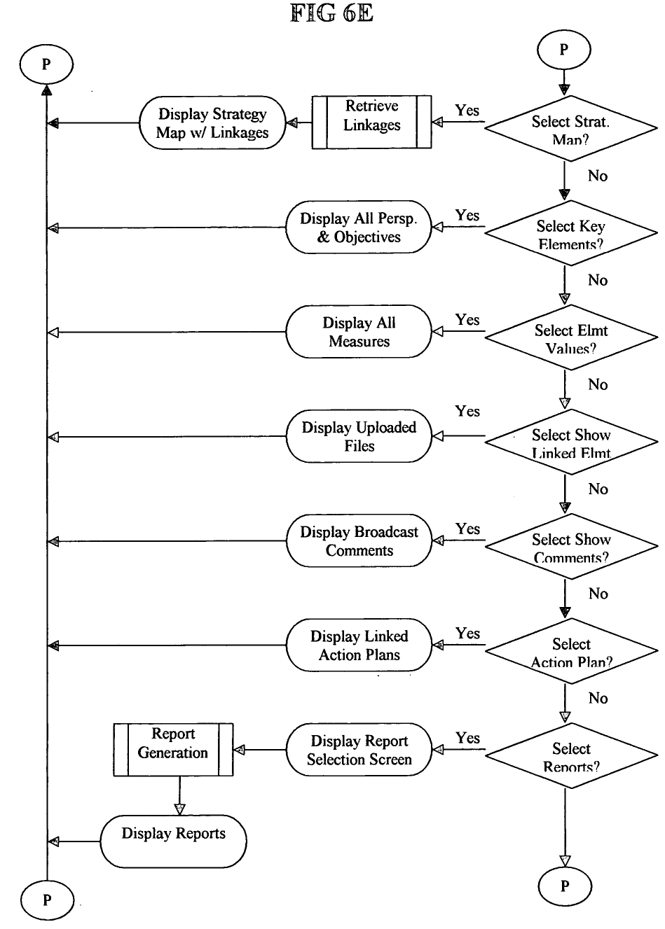

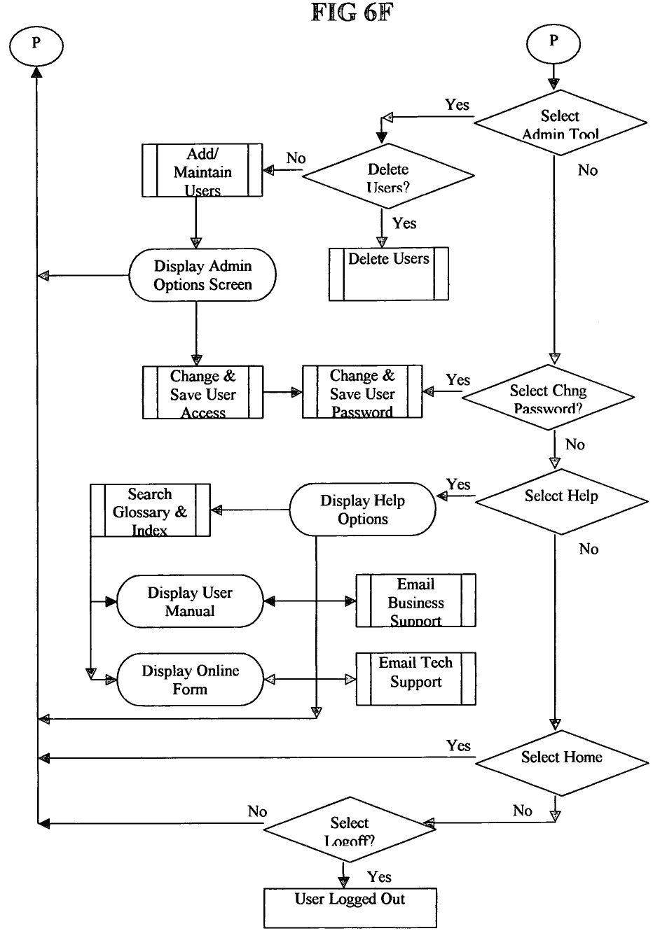

FIG. 5 illustrates the apparatus supporting the corporate performance management system, which includes at least one processor (97); at least one Web server (98); at least one database memory unit (99); at least one personal computing device with modem (100); and at least one technical security mechanism (101). The corporate performance management apparatus of at least one processor, at least one memory unit and at least one computing device may be managed external to the organization or located on the customer's premises. Security is required at all touch points.

FIG. 6A illustrates the article of the invention and specifically the at least one security mechanism embedded into the computer readable medium, which is a Web-based software application with coded instructions. No access is provided to users or systems administrators to the software code of the invention. A system administrator interacts with the computer readable medium and may be provided with many options to create an access path for any particular user or group of users. The interaction triggers detailed instructions with respect to how an individual can log on to the application from any personal computer with Internet connectivity (102); what they see upon initial access to the Web-based software application (103, 110); areas typically only the systems administrator may access, including creating links (104), creating tree structure (105) or creating functions (106). The systems administrator may further interact with the application to select an application (107), select an element (108) or select a menu icon (109). A systems administrator may have rights to add or change rights or to assign rights at a detailed level, including access to links, reporting/tree structure, functions, applications, data elements, menu icons or any other aspect of the software application.

FIG. 6B illustrates additional aspects of security embedded into the corporate performance management system and software to manage how a user may access, view and interact with various software application components of the invention under a single sign-on within a single Web browser window. User authentication, via biometric authentication or unique identification and password, may be collected at sign-on and rechecked by the system at all points in the user's path that require authentication, transparently to the user and without delay. Unauthorized users would be stopped upon initial entry. Users authorized to access certain aspects of the system and software will in most cases only see options where access is granted. For example, a menu icon that represents a restricted area would not be presented in the screen viewed by the restricted user, eliminating confusion often caused by access warnings or error messages. A user may be restricted from access to certain applications, functions or forms, data elements, links, comments, reporting levels or areas or may be restricted in their interaction within in certain areas. For example, a user may be restricted from viewing a particular metric. The user would be restricted to view the metric through the Scorecard application or any other application, nor would they be able to access the information by running reports or performing ad hoc query; user access is tied to the root level of the data, function or icon.

FIG. 6C illustrates how a user might access corporate performance data in a variety of ways including: graphical views; dashboards; charts and tables; query for more detail about a reported value; import data to populate values not yet reported via automated transfer; export values for additional charting, comparison or what if analysis using a separate, integrated application or desktop application, such as Excel; and edit target and alarm values.

FIG. 6D illustrates how a user might view additional information related to at least one metric and query for further information about that metric, including: associated events or initiatives; type of measure; formula used for the measure; track the reported value to the initial organizational level of measurement; or add or display comments related to the corporate performance data.

FIG. 6E illustrates the options within the corporate performance management system that encourage collaboration, including display of the stakeholder perspectives, objectives, themes or measures respective of the strategy those values align with, view uploaded supporting materials, comments that have been broadcast from a higher organizational level, action plans and reports of results. The user is given the opportunity to provide feedback via text or uploaded file in response to the results of the interaction.

FIG. 6F illustrates how a system administrator might interact with the corporate performance management system to update user access rights (also see [0051]), add or change users, change passwords, receive help through help index, administrator or user manuals, online support, e-mail or online chat or process an online request form.

While the invention has been described in conjunction with the detailed description thereof, the foregoing description is intended to illustrate and not to limit the scope of the invention. Modifications by one skilled in the art may effect the invention without departing from the spirit or scope of the invention as defined in the appended claims.

1. A method of capturing critical corporate performance drivers, including provision of a means to capture softer drivers, such as human thoughts, concepts and actions, which may reside in electronic form in at least one local system, yet often in disparate and/or previously accessible systems, or in paper form, or in no tangible until access to the corporate performance management system is gained, and manually entered to the corporate performance management system via an intuitive Web browser interface; integrating the corporate performance data into a single repository; filtering, aggregating and organizing the corporate performance data into at least one metric; further aggregating and presenting the at least one metric at every organizational reporting level above the level at which the metric was captured; interpret the data in a concise presentation for decision-makers; provide for interactive, on-line access to the system and data; providing for digital security during transmission, as accessed for presentation or ad hoc query, and when stored; maintaining a historical audit trail of the corporate performance data; securely archiving the corporate performance data and corporate performance-related data archived in a variety of formats; and providing a means to communicate with people and confidentially evaluate, rate and present their performance as it affects corporate performance.

2. The method of claim 1 wherein said capture, filtering, aggregation, presentation, query and communication of corporate performance data and corporate performance-related data are enabled with Web services technologies used to develop software code for one or more software applications that may be read directly from the Internet, managed from a single database and processed within a single system such that security and control are maximized and maintenance costs are minimized.

3. The method of claim 1 wherein provision for interactive access to the system may be comprised: a readiness assessment survey, reports and action plan; a strategy map; at least one organized metric in a scorecard, reports and dashboard; ad hoc database query; employee evaluation and testing; users manual; help index; glossary of corporate performance-related terms; e-mail communication with the help desk or other users if authorized; live chat with a technical support person, systems administrative functions and online request forms for system or report customization.

4. The method of claim 3 wherein the readiness assessment survey, reports and action plan are incorporated within a single software application, fully integrated with other applications within the corporate performance management system and including an online, interactive readiness assessment survey directed to the ability to capture corporate performance data manually or electronically, via scanning, system integration, import or upload, on a timely basis and with minimal interruption to workflow; assessment reports; analysis reports; management reports and presentation of action steps automatically generated in Microsoft Project and linked directly to the survey results.

5. The method of claim 1 wherein the filtered corporate performance data, which may be comprised of simple or complex data sets having different units of measure and extracted from disparate systems and applications and from many locations anywhere in the World, is aggregated and presented in a concise presentation, in real time or as defined by the user, with functionality that encourages and enables feedback, all from a single Web browser window accessed with a single secure sign on.

6. The method of claim 1 wherein to bring all corporate performance data together comprises organizing the captured, filtered and aggregated data into at least one metric; assigned to an individual or organizational unit; secured with respect to user ability to view, change or query the metric; presented numerically and graphically, such that its relationship with at least one corporate objective is known and its comparative value relative to desired performance is captured; and shown to be as expected or better than expected, less favorable than expected but within tolerance or under-performing and in need of intervention.

7. The method of claim 6 wherein organizing the data into at least one metric further comprises filtering the data in accordance with rules and formulas whereby quantitative or qualitative data can be translated automatically, with formulas built into software code, into useful and relevant comparable values to be presented via a single Web browser.

8. The method of claim 1 wherein security is embedded into the system to ensure that only an authorized user may receive, transmit, view, retrieve, save, request or export all or part of the captured, filtered and aggregated information and any unauthorized attempt to access the corporate performance software, system or apparatus will be stopped and an alarm delivered to the system administrator.

9. The method of claim 1 wherein an authorized user may not have access to some of the corporate performance data and may not have access all aspects of the corporate performance management system such that unauthorized access may include not having access to specified data or data sets in transit, as presented or as storage nor to a specified functional aspect, uploaded file, linked application, query, report, private comment or enterprise broadcast transmitted through or stored within the corporate performance management system.

10. The method of claim 1 wherein a historical audit trail may be maintained of all transactions and user access or attempted access related to the corporate performance management system, which may include user ID, system date and time.

11. A system comprising: at least one remotely located application server; at least one database server located locally or remotely; at least one Web server located locally or remotely; a computing device with Internet connectivity; and a local processor device, wherein the processor device is configured to obtain corporate performance data from the at least one remotely located application server and as manually entered directly to the system from an intuitive Web-browser interface, at least one database server and a Web server; filter, aggregate and organize the corporate performance data into at least one metric; further aggregate and present the at least one metric at every organizational reporting level above the level at which the metric was captured; provide secure, interactive access through the Internet to the corporate performance data and corporate performance-related data archived in a variety of formats; and provide a means to communicate with people and confidentially evaluate, rate and present their performance as it affects corporate performance.

12. The system of claim 11 providing the means to move all or selected data from one or more systems, with unlimited frequency and without manual intervention, through a processor device, to at least one database server and to the Internet for access to users from a Web browser window, which may be located by the user via a desktop shortcut icon or direct entry of a uniform resource locator (URL) into their Web browser.

13. The system of claim 11 wherein the processor device is further configured to organize assessment survey responses at an individual level, a group level and an enterprise level, categorize the survey responses in accordance with predetermined action steps and present reports, charts and tables intended for readiness assessment, analysis of survey responses or a detailed MS Project plan outlining action steps.

14. The system of claim 11 wherein the processor device is further configured to filter and aggregated data to generate metrics in accordance with a predetermined formula and organize the data at an individual level, a group level, and an enterprise level and identify if a predetermined set value, for the data organized into the at least one metric, has been met, exceeded or not met.

15. The system of claim 11 wherein the processor device is further configured to compare a value at least one metric with a value of an event, initiative or action plan assigned to that metric such that an automated response is delivered via the Internet.

16. The system of claim 11 wherein the processor device is further configured to privately route or publicly broadcast communication from an individual, or as automatically generated by the system, to the intended receiver(s) and/or to the intended presentation view or report within the corporate performance management system.

17. The system of claim 11 wherein the processor device is further configured to identify user authenticity and restrict access to data or other aspects of the corporate performance management system only to authorized users of that data or aspect.

18. The system of claim 11 wherein the processor device is further configured to maintain a historical audit trail of all user access, access attempts, transactions and queries associated with the corporate performance management system.

19. An apparatus comprising: at least one processor; at least one Web server, at least one memory unit, at least one personal computing device with Internet connectivity and at least one technical security mechanism; wherein the security mechanism(s) is configured to secure digitized data—including metrics, notes, uploaded files, linked applications, private comments, enterprise broadcasts, forms, reports, queries and views—as it is received or transmitted from one or more systems supported by at least one Web server and a VPN or encrypted, with unlimited frequency and without manual intervention; the a processor device is configured to filter, aggregate and organize the data into at least one metric that may be further categorized, assign a responsibility center or individual to the data and the data as organized into at least one metric, and further assign role based security instructions such that an individual is identified by unique sign on or biometric authentication and offered access to all or part of any data, function, area, application, communication, report or query; and store the data on at least one memory unit such that is secured from unauthorized access and retrievable at anytime from anywhere in the World and only by authorized users via a personal computing device with Internet connectivity.

20. An article comprising one or more computer-readable Web-based software code that stores computer executable instructions for causing a computer system to: accept the corporate performance related data from at least one remotely located application server, manual entry, file upload and file import; organize the corporate performance related data that has into at least one metric; filter, aggregate and roll up the corporate performance metric from its level within the organization to at least one metric at the corporate level, compare the at least one metric to predetermined targets and alarms; provide secure, interactive access through the Internet to the corporate performance data organized into a scorecard and presented within a single Web browser window; maintain and secure an historical audit trail of access, attempted access and transactions; provide secure archival of the corporate performance data and support materials; and provide for secure communication between individuals including evaluation, rating and testing individual performance as it relates to corporate performance.

21. The article of claim 20 further comprising a computer readable Web-based software applications that may include or otherwise link to: a first set of data stored digitally on a data storage medium and having contained therein data concerning strategic objectives, related metrics and levels of exception identified as targets and alarms for each metric; a second set of data stored digitally on a data storage medium and having contained therein the organizational structure and assigned responsibilities; a third set of data stored digitally on a data storage medium and containing sample corporate performance metrics and benchmarks, along with prescribed action steps given various levels of readiness by type of metric, importance and level of responsibility; a fourth set of data stored digitally on a data storage medium and having contained therein the historic and current actual performance data that may be captured daily, weekly, monthly, quarterly and annually; a fifth set of data stored digitally on a data storage medium and containing budgeting or planning data; a sixth set of data stored digitally on a data storage medium and containing individual evaluation and testing data.

22. The article of claim 20 wherein the computer readable medium containing computer executable instructions may cause the computer system to allow authorized users access to one or more of the following aspects of one or more software applications presented within a single Web browser window: respond to a series of questions related to the availability and form of data critical to the reporting of corporate performance; review plans with respect to data capture; view strategic plans; perform what if scenarios; create or view strategy maps; view interactive presentation of corporate performance results within a balanced scorecard framework; drill down from a presented corporate performance metric to the individual corporate performance data comprising that metric, at its root level within a balanced scorecard framework or via ad hoc query into the data as received or as received and organized into at least one metric; create and share comments with other authorized users; upload or download supporting documentation; view and print reports; perform ad hoc query; create and communicate events, initiatives and action plans; access help desk and documentation; view or create an online request form; import or export from or to the corporate performance management system from a local system; and evaluate, rate and test employees with respect to their performance, including as comparison and linkage to corporate strategic objectives.

23. The article of claim 20 further comprising instructions for causing the computer system to determine a recommended action based on the response to an assessment survey, group responses by level, category and enterprise; provide assessment, analysis and management reports as well as ad hoc query and automatically generate detailed action steps, as recommended based on user response to the assessment survey, in a detailed project plan supported by Microsoft Project.
